(19) United States
(12) Patent Application Publication
(10) Pub. No.: US 2026/0143332 A1
(43) Pub. Date: May 21, 2026

(54) METHODS, SYSTEMS, AND DEVICES FOR MANAGING A COMMUNICATION DEVICE WITH MULTIPLE ELECTRONIC SUBSCRIBER IDENTITY MODULES (ESIMS)

(71) Applicant: AT&T Intellectual Property I, L.P., Atlanta, GA (US)

(72) Inventors: Rashmi Palamadai, Naperville, IL (US); Yupeng Jia, South Pasadena, CA (US)

(73) Assignee: AT&T Intellectual Property I, L.P., Atlanta, GA (US)

(21) Appl. No.: 18/953,175

(22) Filed: Nov. 20, 2024

(51) Int. Cl. H04W 8/24; H04W 8/26; H04W 12/45; H04W 28/24

(52) U.S. Cl. CPC H04W 8/24; H04W 8/265; H04W 12/45; H04W 28/24

(57) ABSTRACT

Aspects of the subject disclosure may include, for example, receiving first instructions from a first communication device, which indicates to activate a first profile of a first electronic subscriber identity module (eSIM), activating the first profile of the first eSIM, receiving second instructions from the first communication device, which indicate to activate a second profile of a second eSIM, and activating the second profile of the second eSIM. Further embodiments include receiving first content from a second communication device, determining that the first content is associated with the first profile, and providing third instructions and the first content to the first communication device, which indicate to present with first content with a first indicator, the first communication device receives the third instructions and the first content presents the first content with the first indicator, which indicates the first content is associated with the first profile. Other embodiments are disclosed.

### FIELD OF THE DISCLOSURE

The subject disclosure relates to methods, systems, and devices for managing a communication device with multiple electronic subscriber identity modules (eSIMs).

### BACKGROUND

As the usage of communication devices and applications continues to grow in mobile network devices, users are less likely to carry multiple communication devices or larger communication devices. Instead, a user relies on the mobile networks to provide the services needed to use a single communication devices (e.g., mobile phone, AR/VR communication device, etc.) that can be used for both personal and professional purposes.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2C are block diagrams illustrating example, non-limiting embodiments of a system functioning within the communication network of FIG. 1 in accordance with various aspects described herein.

FIGS. 2D-2E depicts illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for receiving, over a communication network, first instructions from a first communication device, the first instructions indicate to activate a first profile associated with a first electronic subscriber identity module (eSIM), based on the first instructions, activating the first profile associated with the first eSIM, receiving, over the communication network, second instructions from the first communication device, the second instructions indicate to activate a second profile associated with a second eSIM, and based on the second instructions, activating the second profile associated with the second eSIM. Further embodiments include receiving, over the communication network, first content from a second communication device, determining that the first content is associated with the first profile, and providing, over the communication network, third instructions and the first content to the first communication device. The third instructions indicate to the first communication device to present with first content with a first indicator, the first communication device receives the third instructions and the first content, the first communication device presents the first content with the first indicator based on the third instructions, and the first indicator indicates the first content is associated with the first profile. Other embodiments are described in the subject disclosure.

One or more aspects of the subject disclosure include a device, comprising a processing system including a processor, and a memory that stores executable instructions that, when executed by the processing system, facilitate performance of operations. The operations can comprise receiving, over a communication network, first instructions from a first communication device, the first instructions indicate to activate a first profile associated with a first electronic subscriber identity module (eSIM), based on the first instructions, activating the first profile associated with the first eSIM, receiving, over the communication network, second instructions from the first communication device, the second instructions indicate to activate a second profile associated with a second eSIM, and based on the second instructions, activating the second profile associated with the second eSIM. Further operations can comprise receiving, over the communication network, first content from a second communication device, determining that the first content is associated with the first profile, and providing, over the communication network, third instructions and the first content to the first communication device. The third instructions indicate to the first communication device to present with first content with a first indicator, the first communication device receives the third instructions and the first content, the first communication device presents the first content with the first indicator based on the third instructions, and the first indicator indicates the first content is associated with the first profile.

One or more aspects of the subject disclosure include a non-transitory machine-readable medium, comprising executable instructions that, when executed by a processing system including a processor, facilitate performance of operations. The operations can comprise receiving, over a communication network, first instructions from a first communication device, the first instructions indicate to activate a personal profile associated with a first electronic subscriber identity module (eSIM), based on the first instructions, activating the personal profile associated with the first eSIM, receiving, over the communication network, second instructions from the first communication device, the second instructions indicate to activate a professional profile associated with a second eSIM, and based on the second instructions, activating the professional profile associated with the second eSIM. Further operations can comprise receiving, over the communication network, first content from a second communication device, determining that the first content is associated with the personal profile, and providing, over the communication network, third instructions and the first content to the first communication device, the third instructions indicate to the first communication device to present with first content with a first indicator. The first communication device receives the third instructions and the first content, the first communication device presents the first content with the first indicator based on the third instructions, and the first indicator indicates the first content is associated with the personal profile.

One or more aspects of the subject disclosure include a method. The method can comprise receiving, by a processing system comprising a processor, over a communication network, first instructions from a first communication device, the first instructions indicate to activate a first profile associated with a first electronic subscriber identity module (eSIM), based on the first instructions, activating, by the processing system, the first profile associated with the first eSIM, receiving, by the processing system, over the communication network, second instructions from the first communication device, the second instructions indicate to activate a second profile associated with a second eSIM, and based on the second instructions, activating, by the processing system, the second profile associated with the second eSIM. Further operations can comprise receiving, by the processing system, over the communication network, first content from a second communication device, determining, by the processing system, that the first content is associated with the first profile utilizing an artificial intelligence (AI) software application, and providing, by the processing system, over the communication network, third instructions and the first content to the first communication device, the third instructions indicate to the first communication device to present with first content with a first indicator, the first communication device receives the third instructions and the first content, the first communication device presents the first content with the first indicator based on the third instructions, and the first indicator indicates the first content is associated with the first profile.

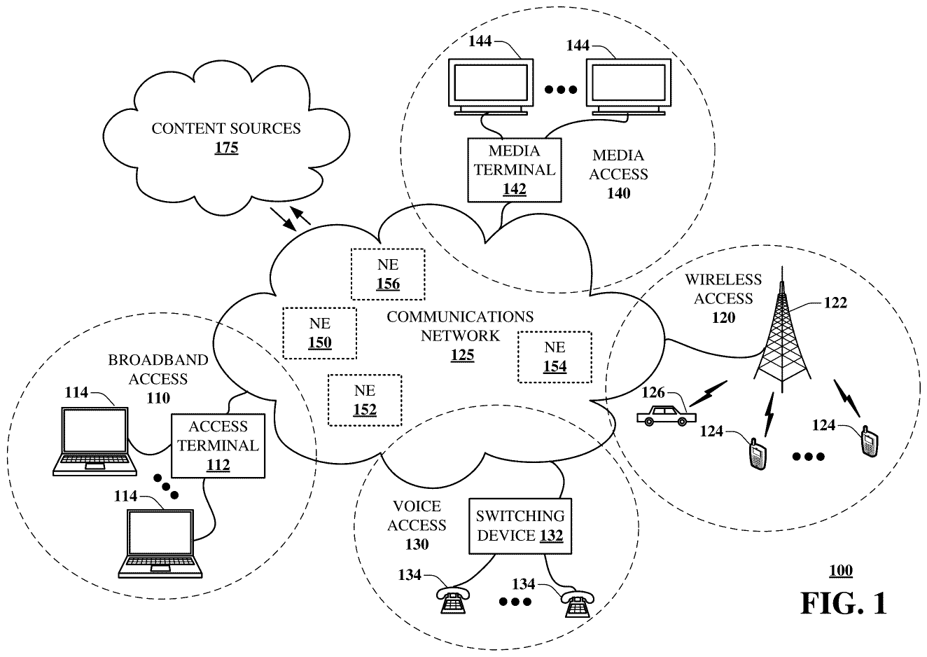

Referring now to FIG. 1, a block diagram is shown illustrating an example, non-limiting embodiment of a system 100 in accordance with various aspects described herein. For example, system 100 can facilitate in whole or in part managing different content for different SIMs on a communication device. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

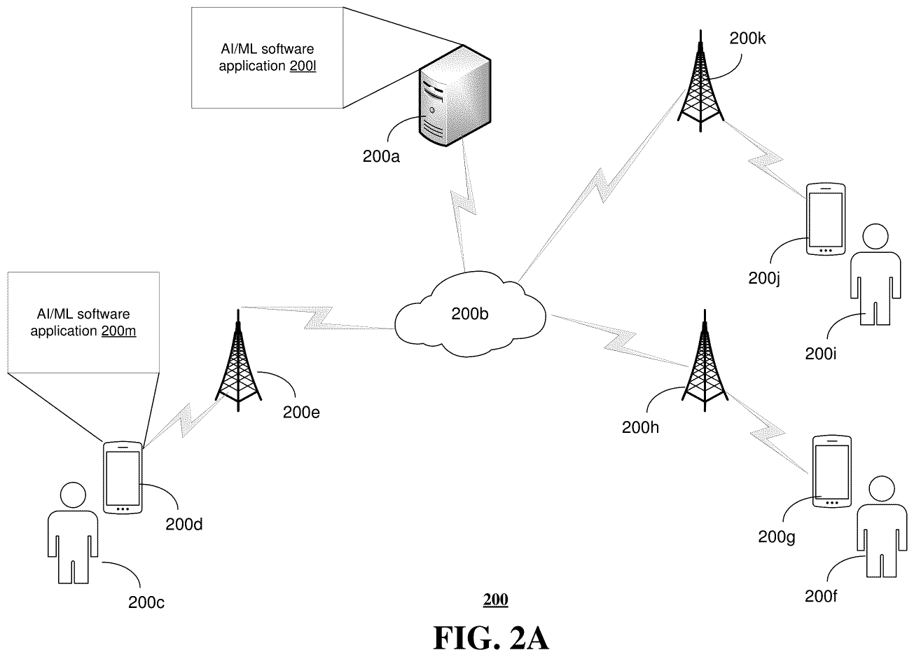

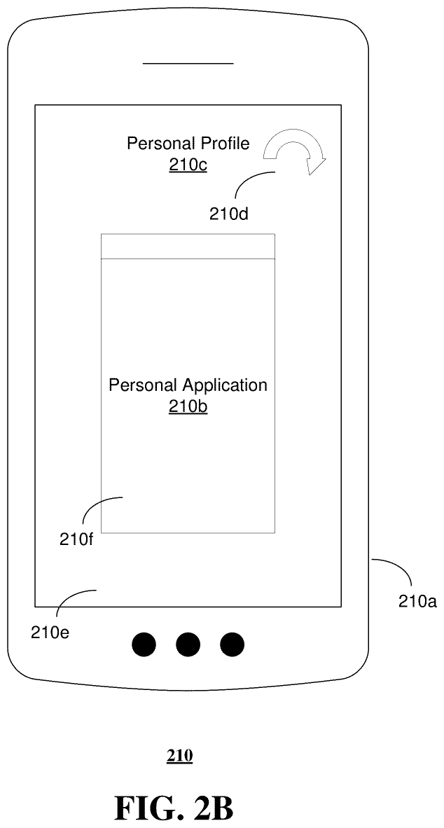

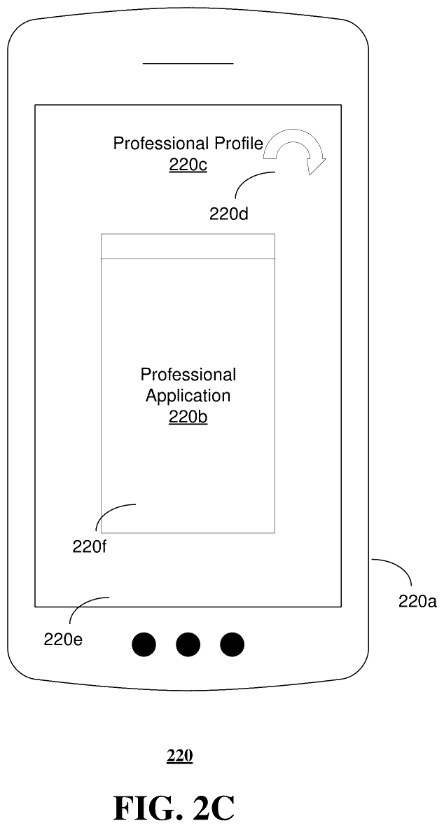

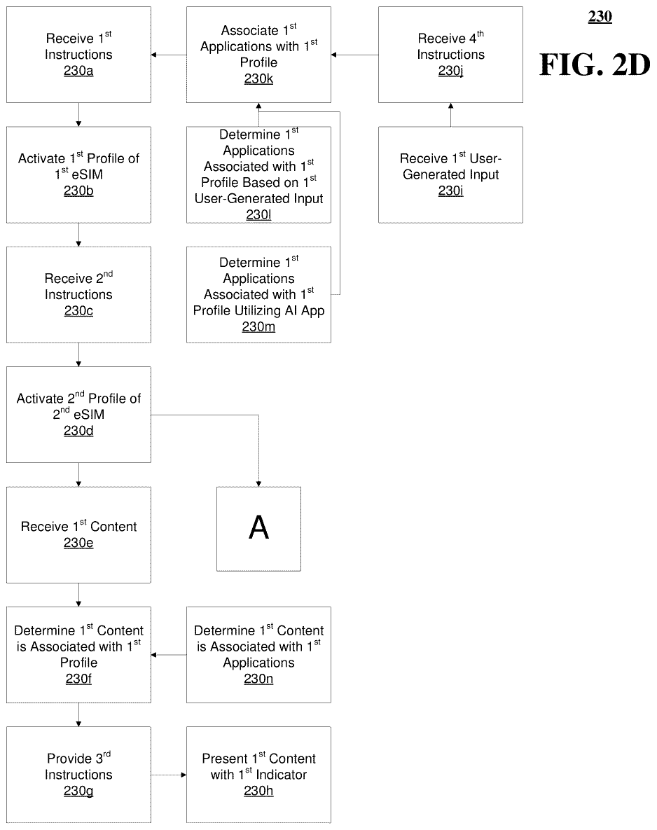

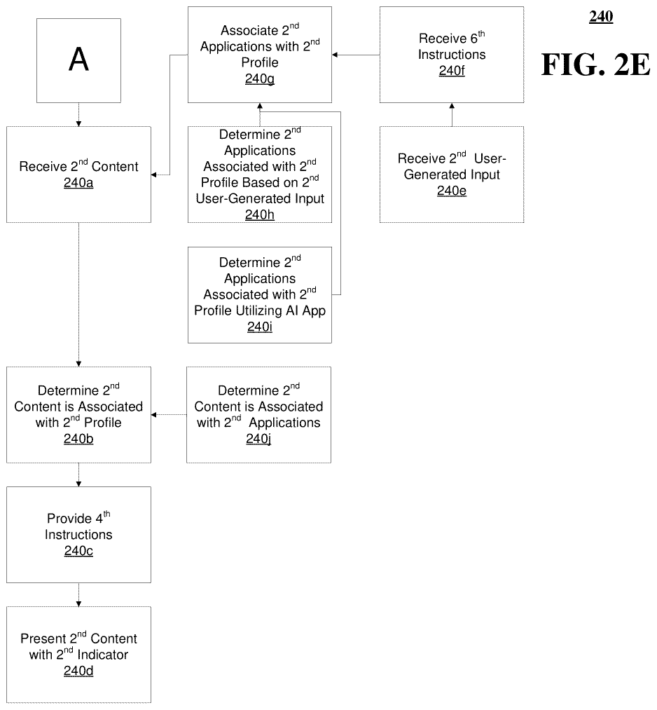

FIGS. 2A-2C are block diagrams illustrating example, non-limiting embodiments of a system functioning within the communication network of FIG. 1 in accordance with various aspects described herein. Referring to FIG. 2A, in one or more embodiments, system 200 can include a server 200a communicatively coupled to base station 200e, base station 200h, and base station 200k over communication network 200b. Further, communication device 200d associated with user 200c can be communicatively coupled over a wireless network to base station 200e. In addition, communication device 200g associated with user 200 f can be communicatively coupled over a wireless network to base station 200h. Also, communication device 200j associated with user 200i can be communicatively coupled over a wireless network to base station 200k. In further embodiments, server 200a can comprise an artificial intelligence (AI)/machine learning (ML) software application 200l, and communication device 200d can comprise an AI/ML software application 200m.

In one or more embodiments, server 200a can comprise one or more servers residing in one location or spanning multiple locations, one or more virtual servers residing in one location or spanning multiple locations, one or more cloud servers, or a combination thereof. Further, server 200a can comprise a network device within a mobile network that can assist managing the mobile network, which comprises base station 200e, base station 200h, and base station 200k. In addition, communication network 200b can comprise one or more wireless communication networks, one or more wired communication networks or a combination thereof. Also, each of communication device 200 d, communication device 200g and communication device 200 j can comprise a mobile phone, smartphone, mobile, device, augmented reality device, cross-reality device, wearable device, laptop computer, desktop computer or any other communication device.

In one or more embodiments, the user 200c can configure communication device 200d with a personal profile and professional profile. Further, the user 200c can configure the personal profile to be associated with one electronic subscriber identity module (eSIM) associated with communication device 200d and configure the professional profile to be associated with another eSIM associated with communication device 200d. In some embodiments, the user 200c can configure the personal profile to be associated with one SIM associated with communication device 200d and configure the professional profile to be associated with another SIM associated with communication device 200d. The personal profile can be utilized when the user 200c utilizes personal (software) applications and consumes, views, or otherwise interacts with personal content associated with one or more of the personal applications. The professional profile can be utilized when the user 200c utilizes professional (software) applications and consumes, views, or otherwise interacts with professional content associated with one or more of the professional applications. Such use of different eSIMs, each associated with a different profile, allows user 200c to utilize communication device 200d in different ways without resorting to utilizing one communication device for personal use and utilizing a different communication device for professional use.

In one or more embodiments, user 200c can provide user-generated input to communication device 200d. The user-generated input can indicate a group of applications associated with the personal profile. Further, communication device 200d can provide instructions to server 200a over communication network 200b via base station 200e. The instructions can include the group of applications associated with the personal profile. In some embodiments, the AI/ML software applications 200m can determine the group of applications associated with the personal profile instead of, or in addition to the provided user-generated input. That is, the AI/ML software application 200m can monitor and analyze user 200 c utilizing different applications on communication device 200d and determine from context (analyzing text, images, video, etc.) that a group of applications are for personal use. Further, the server 200a can receive the instructions that indicate the group of applications associated with a personal profile and associate the group of applications with the personal profile (e.g., in a table, database, etc.), accordingly.

In one or more embodiments, user 200c can provide other user-generated input to communication device 200d. The other user-generated input can indicate a group of applications associated with the professional profile. Further, communication device 200d can provide instructions to server 200a over communication network 200b via base station 200e. The instructions can include the group of applications associated with the professional profile. In some embodiments, the AI/ML software applications 200m can determine the group of applications associated with the professional profile instead of, or in addition to the provided other user-generated input. That is, the AI/ML software application 200m can monitor and analyze user 200 c utilizing different applications on communication device 200d and determine from context (analyzing text, images, video, etc.) that a group of applications are for professional use. Further, the server 200a can receive the instructions that indicate the group of applications associated with a professional profile and associate the group of applications with the professional profile (e.g., in a table, database, etc.), accordingly. In some embodiments, an application can be associated with both the personal profile and the professional profile. However, user 200c can utilize different accounts. That is, one user account for the application can be for personal use and another user account for the application can be for professional use.

In one or more embodiments, server 200a can receive over communication network 200b, instructions from communication device 200d. The instructions can indicate to activate a personal profile associated with an eSIM (e.g., that the personal profile has been activated on communication device 200d). Based on these instructions, the server 200a can activate the personal profile associated with the eSIM. Further, the user 200c can provide user-generated input to communication device 200d, which indicates to provide the instructions to activate the personal profile associated with the eSIM. In further embodiments, server 200a can receive over communication network 200b, other instructions from communication device 200d. These instructions can indicate to activate a professional profile associated with a different eSIM (e.g., that the professional profile has been activated on communication device 200d. Based on these instructions, the server 200a can activate the professional profile associated with this different eSIM. In addition, the user 200c can provide different user-generated input to communication device 200d, which indicates to provide the instructions to activate the professional profile associated with the eSIM. The personal profile and professional profile can be activated at the same time on both communication device and server 200a.

In one or more embodiments, server 200a can receive, over the communication network 200b, content from a communication device 200j of user 200i via base station 200k. Further, server 200a can determine that the content is associated with a personal profile because the content is associated with a personal application (e.g., streaming application, personal email application, personal social media application, etc.). In some embodiments, the server 200a can utilize AI/ML software applications 200l to determine whether the content is associated with a particular profile. In addition, the server 200a can provide, over the communication network 200b, instructions and the content to communication device 200d via base station 200e. The instructions can indicate to communication device 200d to present with content with an indicator. The communication device 200d can receive the instructions and the content. Communication device 200d presents the content with the indicator based on the instructions. The indicator can indicate the content is associated with the personal profile.

In one or more embodiments, server 200a can receive, over the communication network 200 b, content from a communication device 200g of user 200 f via base station 200h. Further, server 200a can determine that the content is associated with a professional profile because the content is associated with a professional application (e.g., professional database application, professional email application, professional video conferencing application, etc.). In some embodiments, the server 200a can utilize AI/ML software applications 200l to determine whether the content is associated with a particular profile. In addition, the server 200a can provide, over the communication network 200b, instructions and the content to communication device 200d via base station 200e. The instructions can indicate to communication device 200d to present with content with an indicator. The communication device 200d can receive the instructions and the content. Communication device 200d presents the content with the indicator based on the instructions. The indicator can indicate the content is associated with the professional profile.

In one or more embodiments, in response to receiving an indication from communication device 200d that a professional profile is activated, the server 200a can allocate a group of network resources to communication device 200d. However, in response to receiving an indication from communication device 200d that a personal profile is activated, the server 200a can allocate a different group of network resources to communication device 200d.

In one or more embodiments, user 200c can log into communication device 200d utilizing user credentials associated with a personal profile to activate the personal profile. Further, user 200c can log into another communication device utilizing the same user credentials associated with the personal profile to activate the personal profile on the other communication device.

In one or more embodiments, server 200a can provide user profile management for a mobile network operator. In some embodiments, user 200c can register a personal profile and professional profile with the mobile network operator via communication device 200d. Further, server 200a can access details associated with each of the personal profile and the professional profile. In addition, multiple eSIMs can be associated with each profile. ESIM details associated with each user account are also registered and managed to allow for the user to travel internationally as well as have a connection to non-terrestrial networks in rural areas without access to terrestrial networks. Also, the mobile network operator can manage the eSIM details associated with the personal profile and the eSIM details associated with the professional profile separate and inaccessible to each other. In further embodiments, the personal profile can be associated with one SIM and the professional profile can be associated with another SIM. Further, there can be a visual difference between each of the SIMs and profiles that allows users to differentiate between profiles and SIMs. In additional embodiments, there can be no overlap between the segmented memory, RAM, hardware partitions and segmentation for each profile on communication device 200d. In other embodiments, user 200c can select which profile is associated with each application. In some embodiments, user 200c can configure different profiles to be associated with the same application.

In one or more embodiments, server 200a can manage network services for each profile. This can include, but not limited to, managing network resources and prioritizing network resources according to profile, user account, location, availability, etc. Further, the server 200a can coordinate with communication device 200d to differentiate between profiles and their associated SIMs, applications, etc.

In one or more embodiments, communication device 200d or the operating system (OS) associated with communication device 200d can manage the profiles stored on associated with communication device 200d. Communication device 200d and/or OS can manage the switch between a personal profile and professional profile. For example, if user 200c downloads a social media application while utilizing a personal profile, the social media application is not associated with a professional profile. If user 200c associates common application to both the personal profile and the professional profile (e.g., travel application), it would be managed with separate user accounts but linked by the provider of the common application. If user 200c logs into the common application utilizing the professional profile details, user 200c can switch to the personal profile on communication device 200d as needed. Further, an OS on one communication device can determine what has changed with the associated profile and the application on another OS on another communication device. For example, a streaming application can be remotely downloaded to one device with an OS. When the user logs into another communication device with another OS with the same profile, the profile on the other communication device can be synchronized (e.g., the streaming application is already downloaded) with the streaming application or prompts the user to approve the synchronization and the streaming application can be downloaded. In some embodiments, a communication device can manage and assist a user to understand which profile they are using by having each profile to be a separate user interface (UI)/look and feel. In further embodiments, a conversational AI.\ML software application can be used to assist the user before sending out critical documents and/or language-tone-inappropriate words/concepts (e.g. political) depending on active profile. In addition, communication device/OS also assists with ensuring only appropriate applications/content/etc. are installed on each profile (e.g., age appropriate, professional vs personal profile appropriate, etc.). Some applications may not be allowed to be associated with a professional profile, but device can redirect them to be associated with a personal profile.

In one or more embodiments, a user can use a single communication device and user credentials for their personal profile and professional profile as well as access specific applications/functions/privileges based on the account details. Further, there can be a separate UI and hardware/software partitions and segmentations so that there is no interference or overlap between profiles. In addition, corporate entities cannot access a user's personal profile details. They may only choose to manage/monitor professional profile and related apps/functions/user actions. User credentials can also function with augmented reality (AR)/virtual reality (VR) setup such that there is no need to physically carry a device, i.e., user credentials can work with headset/AR-VR hardware.

In one or more embodiments, server 200a can provide multi-SIM management. That is, the server 200a manages the SIMs associated with each profile. Applications can be associated with the SIM (within personal or professional). Further, server 200a can bundle applications with separate SIM as part of multi-SIM management.

In one or more embodiments, a user can remotely manage applications such that they can be downloaded onto specific devices remotely, along with any functions/features/content within those applications. Further, when the user logs into personal profile on specified communication device, the applications/functions/features can be available. OS can synchronize the applications/functions/features when the user logs into the specific communication devices.

In one or more embodiments, the AI/ML software application 200l on server 200 a and/or the AI/ML software application 200m on communication device 200 d can learn and understand the difference between a user's personal profile and professional profile as well as differences between accounts on each profile. Further, each of AI/ML software application 200 l and AI/ML software application 200m can have constant improvement and ability to automate the process of accounts, synchronization between OS, which algorithms to use for “appropriateness checks” on each profile. In addition, each of AI/ML software application 200 l and AI/ML software application 200m can learn better ways to share differences between profiles depending on user needs (e.g., if user is color-blind or blind, use sound or other indicators). Also, each of AI/ML software application 200 l and AI/ML software application 200m can learn the difference in time/applications between personal profile and professional profile and create intelligent work-processes management for professional profile so that there is less disturbance during downtime (and likewise for personal profile). Further, each of AI/ML software application 200 l and AI/ML software application 200m can include deep learning that understands which profile is associated with categories of applications. That is, better associations learned/recommended to the user on which profile and SIM to engage for specific purposes.

In one or more embodiments, a user 200c can be utilizing a social media application on communication device 200d at their workplace using their personal social media account while their professional profile is activated. Server 200a can manage the professional profile such that the user's employer cannot view the personal social media account of the user even though the professional profile is activated. The employer can only view/manage applications, information, and accounts associated with the professional profile.

In one or more embodiments, the SIM associated with the personal profile and the SIM associated with the professional profile can communicate with each other. Only if personal profile is activated (or through specific gesture/permission), the communication device 200d or the server 200a can allocate device resources or network resources for applications associated with the personal profile. However, when user 200c switches to utilizing applications associated with the professional profile, the device resources and network resources can be allocated to the professional profile accordingly.

In one or more embodiments, user 200c while utilizing an application associated with the professional profile, can pause use of application and activation of the personal profile, then switch to activating the personal profile and utilize an application associated with the personal profile (e.g., text messaging application). Further, the user 200c can switch back to activating the professional profile after completing use of the application associated with the personal profile and resume use of the application associated with the professional profile.

In one or more embodiments, the user 200c can download an application to communication device 200d. The communication device 200d can prompt the user to associate the downloaded application to either the personal profile, professional profile, or both. Further, an application can be associated with a SIM that is either associated with the personal profile, professional profile, or both. This can allow the user 200c to have mobile number, mobile account, and credit card payment account associated with each profile. Thus, there is less cost to user 200c because they do not have to obtain a separate communication device for personal and professional use because mobile operator is managing the different profiles and associated payment accounts.

In one or more embodiments, communication device 200d can act as a hotspot for AR/VR applications some of which can be associated with the personal profile and others can be associated with the professional profile.

In one or more embodiments, if an application is downloaded but not associated with a profile at the time of download, then AI/ML software application 200m can automatically associate the application to a profile. Further, the AI/ML software application 200m can learn better ways to share differences between profiles depending on user 200c needs (e.g. if user 200c is color-blind or blind, uses sound or other indicators to indicate different profiles). In addition, the AI/ML software application 200m can learn the difference in time/applications between personal and professional. Also, the AI/ML software application 200m can create intelligent work-processes management for professional profile so that there is less disturbance during downtime (and likewise for personal profile).

In one or more embodiments, a user 200c can instantiate a virtual machine utilizing communication device 200d on a server for personal user and associate the application utilizing the virtual machine to the personal profile accordingly. Although the application on the virtual machine is not associated with the professional profile, the personal profile can communicate that such activity has occurred to the professional profile such that communication device 200d can utilize the virtual machine resources for applications associated with the professional profile, if need be.

In one or mor embodiments, an employer can manage or revoke authentication for a user associated with a professional profile if the user is now a former employee.

In one or more embodiments, user 200c can manage multiple personal profiles each associated with a SIM. If user 200c utilizes a gaming application and associates to each personal profile, the communication device 200d can utilize the network resources associated with each SIM for the gaming application.

In one or more embodiments, communication device 200d can implement a virtual OS to manage one or more profiles associated with the user 200c.

In one or more embodiments, each of the personal profile and professional profile can indicate at least one of quality-of-service (QoS) requirements or network slicing requirements such that when server 200a provides respective content associated with either the personal profile or the professional profile, it provides the respective content according to at least one of the QoS requirements or network slicing requirements indicated in the respective profile.

Referring to FIG. 2B, in one or more embodiments, system 210 can include communication device 210a. In response to receiving instructions described herein and personal content 210f, the communication device 210a can present personal content 210f within a personal application 210b on a display 210e of the communication device 210a. Further, the communication device 210a can present an indicator 210d on the display 210e that the personal application 210b and the personal content 210f are associated with the personal profile. In addition, the communication device 210a can present a profile switch button 210d to allow a user to toggle, swipe or switch from a personal profile to a professional profile associated with communication device 210a. In some embodiments, the indicator 210c of whether the personal content 210f or personal application 210b is associated with a personal profile can be an audible indicator (e.g., an audible tone) associated with personal profile or a tactile indicator (e.g., a series of vibrations of communication device 210a) in addition or instead of a visual indicator 210c.

Referring to FIG. 2C, in one or more embodiments, system 220 can include communication device 220a. In response to receiving instructions described herein and professional content 220f, the communication device 220a can present professional content 220f within a professional application 220b on a display 220e of the communication device 220a. Further, the communication device 220a can present an indicator 220c on the display 220e that the professional application 220b and the professional content 220f are associated with the professional profile. In addition, the communication device 220a can present a profile switch button 220d to allow a user to toggle, swipe or switch from a professional profile to a personal profile associated with communication device 220a. In some embodiments, the indicator 220b of whether the professional content 220f or professional application 220b is associated with a professional profile can be an audible indicator (e.g., an audible tone) associated with professional profile or a tactile indicator (e.g., a series of vibrations of communication device 220a) in addition or instead of a visual indicator 220c.

FIGS. 2D-2E depicts illustrative embodiments of methods in accordance with various aspects described herein. Referring to FIG. 2D, in one or more embodiments, aspects of method 230 can be performed by a server or a communication device. Method 230 can include a server, at 230a, receiving, over a communication network, first instructions from a first communication device. The first instructions indicate to activate a first profile associated with a first electronic subscriber identity module (eSIM). Further, the method 230 can include the server, at 230b, based on the first instructions, activating the first profile associated with the first eSIM. In addition, the method 230 can include the server, at 230c, receiving, over the communication network, second instructions from the first communication device. The second instructions indicate to activate a second profile associated with a second eSIM. Also, the method 230 can include the server, at 230d, based on the second instructions, activating the second profile associated with the second eSIM. Further, the method 230 can include the server, at 230e, receiving, over the communication network, first content from a second communication device. In addition, the method 230 can include the server, at 230f, determining that the first content is associated with the first profile. Also, the method 230 can include the server, at 230g, providing, over the communication network, third instructions and the first content to the first communication device. The third instructions indicate to the first communication device to present with first content with a first indicator. The first communication device receives the third instructions. Further, the method 230 can include the first communication device, at 230h, presenting the first content with the first indicator based on the third instructions. The first indicator indicates the first content is associated with the first profile.

In one or more embodiments, prior to receiving the first instructions, the method 230 can include the first communication device, at 230i, receiving first user-generated input. The first user-generated input indicates that the first group of applications associated with the first profile. The first communication device provides the fourth instructions in response to receiving the first user-generated input. Further, the method 230 can include the server, at 230j, receiving fourth instructions from the first communication device. The fourth instructions indicate a first group of applications associated with the first profile. In some embodiments, the first communication device provides the fourth instructions in response to receiving the first user-generated input. In addition, the method 230 can include the first communication device, at 230l, determining the first group of applications are associated with the first profile based on the first user-generated input. Also, the method 230 can include the first communication device, at 230m, determining the first group of applications are associated with the first profile utilizing a first AI/ML software application. In additional embodiments, the first communication device provides the fourth instructions in response to determining the first group of applications are associated with the first profile. Further, the method 230 can include the server, at 230k, associating the first group of applications with the first profile.

In one or more embodiments, the method 230 can include the server, at 230n, determining that the first content is associated with the first profile utilizing a second AI software application. In some embodiments, the determining of the first content is associated with the first profile can comprise determining that the first content is associated with the first profile utilizing a second AI software application.

Referring to FIG. 2E, in one or more embodiments, method 240 can be associated with method 230 through block A. Aspects of method 240 can be performed by a server or a communication device. Method 240 can include a server, at 240a, receiving, over the communication network, second content from a third communication device. Further, the method 240 can include a server, at 240b, determining that the second content is associated with the second profile. In addition, the method 240 can include a server, at 240c, providing, over the communication network, fifth instructions and the second content to the first communication device. The fifth instructions indicate to the first communication device to present with second content with a second indicator. The first communication device receives the fifth instructions and the second content. The method 240 can include the first communication device, at 240d, presenting the second content with the second indicator based on the fifth instructions. The second indicator indicates the second content is associated with the second profile.

In one or more embodiments, the method 240 can include, prior to receiving the first instructions, the first communication device, at 240e, receiving second user-generated input. The second user-generated input indicates that the second group of applications associated with the second profile. In some embodiments, the first communication device provides sixth instructions in response to receiving the second user-generated input. Further, the method 240 can include the first communication device, at 240h, determining that the second group of applications are associated with the second profile based on the second user-generated input. In addition, the method 240 can include the first communication device, at 240i, determining the second group of applications are associated with the second profile utilizing a third AI/ML software application. In additional embodiments, the first communication device provides the sixth instructions in response to determining the second group of applications are associated with the second profile.

In one or more embodiments, the method 240 can include the server, at 240f, receiving sixth instructions from the first communication device. The sixth instructions indicate a second group of applications associated with the second profile. Further, the method 240 can include the server, at 240g, associating the second group of applications with the second profile.

In one or more embodiments, the method 240 can include the server, at 240j, determining that the second content is associated with a second application from the second group of applications. In some embodiments, the determining of the second content is associated with the second profile comprises determining that the second content is associated with a second application from the second group of applications. In further embodiments, the determining of the second content is associated with the second profile comprises determining that the second content is associated with the second profile utilizing a fourth AI software application. In additional embodiments, the first profile can comprise a personal profile, and the second profile can comprise a professional profile.

While for purposes of simplicity of explanation, the respective processes are shown and described as a series of blocks in FIGS. 2D-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. One or more blocks of FIGS. 2D and 2E can be performed in response to one or more other blocks.

Portions of some embodiments can be combined with portions of other embodiments.

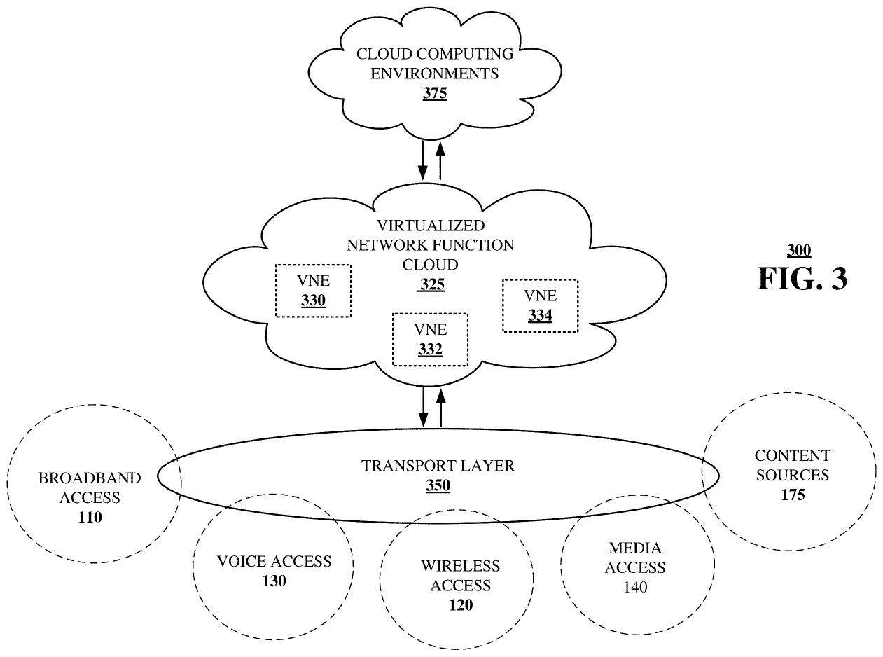

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, system 210, system 220, method 230 and method 240 presented in FIGS. 1, 2A, 2B, 2C, 2D, 2E and 3. For example, virtualized communication network 300 can facilitate in whole or in part managing different content for different SIMs on a communication device.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

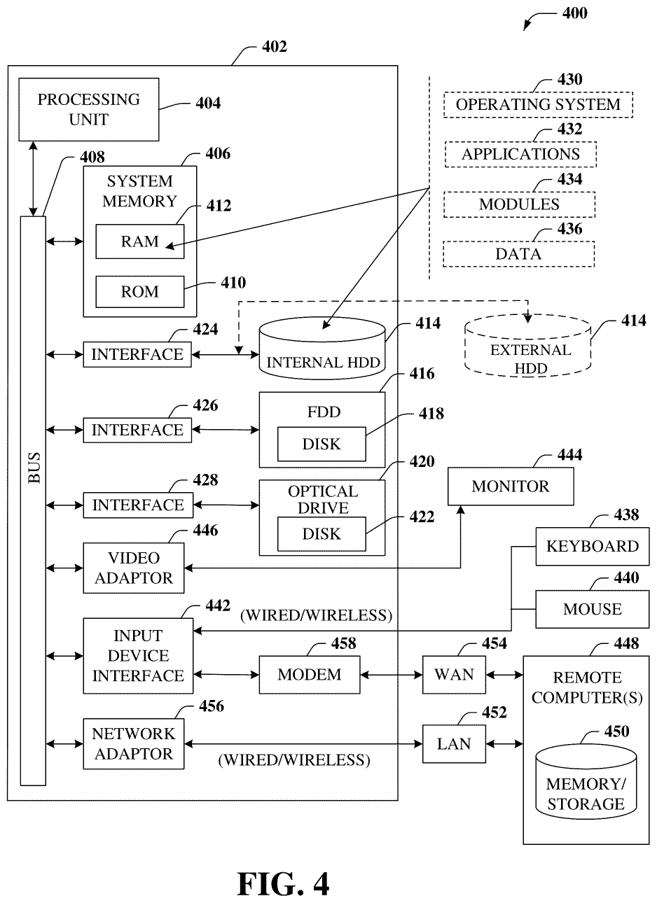

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part managing different content for different SIMs on a communication device. Each of server 200a, communication device 200 d, communication device 200g, communication device 200 j, base station 200 e, base station 200h, base station 200k, communication device 210a, communication device 220a can comprise aspects of computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

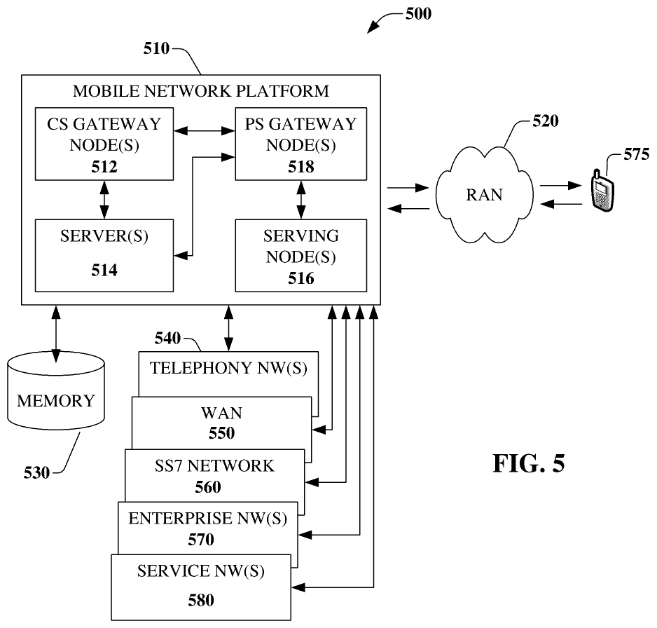

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part managing different content for different SIMs on a communication device. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

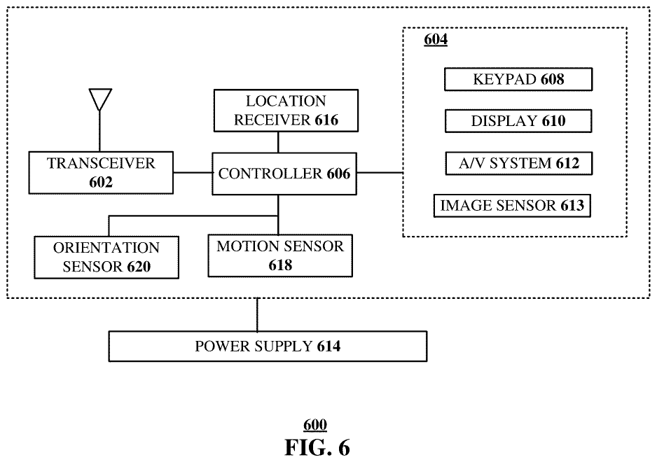

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part managing different content for different SIMs on a communication device. Further, each of server 200 a, communication device 200 d, communication device 200g, communication device 200j, base station 200e, base station 200h, base station 200k, communication device 210a, communication device 220a can comprise aspects of communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, over a communication network, first instructions from a first communication device, wherein the first instructions indicate to activate a first profile associated with a first electronic subscriber identity module (eSIM);
based on the first instructions, activating the first profile associated with the first eSIM;
receiving, over the communication network, second instructions from the first communication device, wherein the second instructions indicate to activate a second profile associated with a second eSIM;
based on the second instructions, activating the second profile associated with the second eSIM;
receiving, over the communication network, first content from a second communication device;
determining that the first content is associated with the first profile; and
providing, over the communication network, third instructions and the first content to the first communication device, wherein the third instructions indicate to the first communication device to present with the first content with a first indicator, wherein the first communication device receives the third instructions and the first content, wherein the first communication device presents the first content with the first indicator based on the third instructions, wherein the first indicator indicates the first content is associated with the first profile.

2. The device of claim 1, wherein the operations comprise:
prior to receiving the first content, receiving fourth instructions from the first communication device, wherein the fourth instructions indicate a first group of applications associated with the first profile; and
associating the first group of applications with the first profile.

3. The device of claim 2, wherein the determining of the first content is associated with the first profile comprises determining that the first content is associated with a first application from the first group of applications.

4. The device of claim 2, wherein the first communication device receives first user-generated input, wherein the first user-generated input indicates that the first group of applications associated with the first profile, wherein the first communication device provides the fourth instructions in response to receiving the first user-generated input.

5. The device of claim 2, wherein the first communication device determines the first group of applications are associated with the first profile utilizing a first artificial intelligence (AI) software application, wherein the first communication device provides the fourth instructions in response to determining the first group of applications are associated with the first profile.

6. The device of claim 1, wherein the determining of the first content is associated with the first profile comprises determining that the first content is associated with the first profile utilizing a second AI software application.

7. The device of claim 1, wherein the operations comprise:
receiving, over the communication network, second content from a third communication device;
determining that the second content is associated with the second profile; and
providing, over the communication network, fifth instructions and the second content to the first communication device, wherein the fifth instructions indicate to the first communication device to present with second content with a second indicator, wherein the first communication device receives the fifth instructions and the second content, wherein the first communication device presents the second content with the second indicator based on the fifth instructions, wherein the second indicator indicates the second content is associated with the second profile.

8. The device of claim 7, wherein the operations comprise:
prior to receiving the second content, receiving sixth instructions from the first communication device, wherein the sixth instructions indicate a second group of applications associated with the second profile; and
associating the second group of applications with the second profile.

9. The device of claim 8, wherein the determining of the second content is associated with the second profile comprises determining that the second content is associated with a second application from the second group of applications.

10. The device of claim 8, wherein the first communication device receives second user-generated input, wherein the second user-generated input indicates that the second group of applications associated with the second profile, wherein the first communication device provides the sixth instructions in response to receiving the second user-generated input.

11. The device of claim 8, wherein the first communication device determines the second group of applications are associated with the second profile utilizing a third artificial intelligence (AI) software application, wherein the first communication device provides the sixth instructions in response to determining the second group of applications are associated with the second profile.

12. The device of claim 7, wherein the determining of the second content is associated with the second profile comprises determining that the second content is associated with the second profile utilizing a fourth AI software application.

13. The device of claim 1, wherein the second profile indicates at least one of quality-of-service (QoS) requirements or network slicing requirements, wherein the providing of the second content comprises providing the second content according to at least one of the QoS requirements or network slicing requirements.

14. The device of claim 1, wherein the first profile comprises a personal profile, wherein the second profile comprises a professional profile.

15. A non-transitory machine-readable medium, comprising executable instructions that, when executed by a processing system including a processor, facilitate performance of operations, the operations comprising:
receiving, over a communication network, first instructions from a first communication device, wherein the first instructions indicate to activate a personal profile associated with a first electronic subscriber identity module (eSIM);
based on the first instructions, activating the personal profile associated with the first eSIM;
receiving, over the communication network, second instructions from the first communication device, wherein the second instructions indicate to activate a professional profile associated with a second eSIM;
based on the second instructions, activating the professional profile associated with the second eSIM;
receiving, over the communication network, first content from a second communication device;
determining that the first content is associated with the personal profile; and
providing, over the communication network, third instructions and the first content to the first communication device, wherein the third instructions indicate to the first communication device to present with the first content with a first indicator, wherein the first communication device receives the third instructions and the first content, wherein the first communication device presents the first content with the first indicator based on the third instructions, wherein the first indicator indicates the first content is associated with the personal profile.

16. The non-transitory machine-readable medium of claim 15, wherein the operations comprise:
prior to receiving the first content, receiving fourth instructions from the first communication device, wherein the
fourth instructions indicate a first group of applications associated with the first profile; and
associating the first group of applications with the first profile.

17. The non-transitory machine-readable medium of claim 16, wherein the determining of the first content is associated with the first profile comprises determining that the first content is associated with a first application from the first group of applications.

18. The non-transitory machine-readable medium of claim 16, wherein the first communication device receives first user-generated input, wherein the first user-generated input indicates that the first group of applications associated with the first profile, wherein the first communication device provides the fourth instructions in response to receiving the first user-generated input.

19. The non-transitory machine-readable medium of claim 16, wherein the first communication device determines the first group of applications are associated with the first profile utilizing a first artificial intelligence (AI) software application, wherein the first communication device provides the fourth instructions in response to determining the first group of applications are associated with the first profile.

20. A method, comprising:
receiving, by a processing system comprising a processor, over a communication network, first instructions from a first communication device, wherein the first instructions indicate to activate a first profile associated with a first electronic subscriber identity module (eSIM);
based on the first instructions, activating, by the processing system, the first profile associated with the first eSIM;
receiving, by the processing system, over the communication network, second instructions from the first communication device, wherein the second instructions indicate to activate a second profile associated with a second eSIM;
based on the second instructions, activating, by the processing system, the second profile associated with the second eSIM;
receiving, by the processing system, over the communication network, first content from a second communication device;
determining, by the processing system, that the first content is associated with the first profile utilizing an artificial intelligence (AI) software application; and
providing, by the processing system, over the communication network, third instructions and the first content to the first communication device, wherein the third instructions indicate to the first communication device to present with the first content with a first indicator, wherein the first communication device receives the third instructions and the first content, wherein the first communication device presents the first content with the first indicator based on the third instructions, wherein the first indicator indicates the first content is associated with the first profile.
